(19) United States
(12) Patent Application Publication
(10) Pub. No.: US 2005/0069771 A1
(43) Pub. Date: Mar. 31, 2005

(54) Positive electrode material for lithium-ion battery

(76) Inventors: Vesselin G. Manev, Flint, MI (US); Vijay P. Saharan, Grand Blanc, MI (US)

Correspondence Address: DELPHI TECHNOLOGIES, INC., M/C 480-410-202, PO BOX 5052, TROY, MI, 48007, US

(21) Appl. No.: 10/675,695

(22) Filed: Sep. 30, 2003

(51) Int. Cl. H01M 4/52

(52) U.S. Cl. 429/223; 429/231.3

(57) ABSTRACT

A composite lithiated nickel-based positive electrode material in which the water-containing excess lithium compounds LiOH and LiHCO₃ have a combined content of at least 10 times lower than the content of the water-free excess lithium compound Li₂CO₃. There is further provided a lithium-ion battery comprising the positive electrode material having the significantly reduced amount of LiOH and LiHCO₃.

### RELATED APPLICATION

This application is related to commonly owned, co-pending U.S. patent application Ser. No. ______ DP-309341 filed on even date and entitled METHOD OF PREPARATION OF POSITIVE ELECTRODE MATERIAL, the disclosure of which is incorporated herein by reference in its entirety as if completely set forth herein below.

### TECHNICAL FIELD

This invention relates to a positive electrode material for lithium-ion and lithium-ion polymer batteries.

### BACKGROUND OF THE INVENTION

Lithium-ion cells and batteries are secondary (i.e., rechargeable) energy storage devices well known in the art. The lithium-ion cell, known also as a rocking chair type lithium battery, typically comprises a carbonaceous negative electrode that is capable of intercalating lithium-ions, a lithium-retentive positive electrode that is also capable of intercalating lithium-ions, and a separator impregnated with non-aqueous, lithium-ion-conducting electrolyte therebetween.

The negative carbon electrode comprises any of the various types of carbon (e.g., graphite, coke, mesophase carbon, carbon fiber, etc.) which are capable of reversibly storing lithium species, and which are bonded to an electrically conductive current collector (e.g., copper foil) by means of a suitable organic binder (e.g., polyvinylidene difluoride, PVDF, PE, PP, etc.).

The positive electrode comprises such materials as transition metal chalcogenides that are bonded to an electrically conductive current collector (e.g., aluminum foil) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂ and LiNiO₂, their solid solutions and/or their combination with other metal oxides.

The electrolyte in such lithium-ion cells comprises a lithium salt dissolved in a non-aqueous solvent which may be (1) completely liquid, (2) an immobilized liquid, (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, polyfluorides and polycarbonates, and may be polymerized in situ in the presence of the electrolyte to trap the electrolyte therein as the polymerization occurs. Known polymers for pure polymer electrolyte systems include polyethylene oxide (PEO), polymethylene-polyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into the pores of the positive and negative electrode and in a separator layer between the positive and negative electrode. The separator may be a porous polymer material such as polyethylene, polyfluoride, polypropylene or polyurethane, or may be glass material, for example, containing a small percentage of a polymeric material, or may be any other suitable ceramic or ceramic/polymer material.

Lithium-ion cells made from pure polymer electrolytes, or liquid electrolytes entrapped in a polymer matrix, are known in the art as “lithium-ion polymer” cells, and the electrolytes therefore are known as polymeric electrolytes. Lithium-polymer cells are often made by laminating thin films of the negative electrode, positive electrode and separator together wherein the separator layer is sandwiched between the negative electrode and positive electrode layers to form an individual cell, and a plurality of such cells are bundled together to form a higher energy/voltage battery.

During the charge process in these lithium-ion rechargeable batteries, lithium-ions are deintercalated (or released) from the positive electrode and are intercalated (or inserted) into layer planes of the carbonous material. During the discharge, the lithium-ions are released from the negative electrode and are inserted into the positive electrode. For a proper function of this rocking chair type charge-discharge mechanism, the surface compositions and properties of both positive and negative electrodes intercalation compound are of substantial importance. In a battery or a cell utilizing lithium-containing intercalation compounds, it is important to eliminate as many impurities as possible that may affect cell performance. The main impurity that contributes to increased cell impedance and decreased cell capacity is water and products generated from reaction of the water with cell electrolyte as HF (hydrogen fluoride). Water may be introduced in the cell as physically bound water during the process of cell preparation, but can also be incorporated as water-containing compounds, which may release water in the cell by a change in equilibrium or by reaction with other cell products during the cell life.

The lithium-ion battery with a nickel-based positive electrode, and in particularly with a general formula LiNi_{X}Co_{Y}M_{Z}O₂, where M is a transition metal or the sum of transition metals different than Ni and Co, has the highest specific energy among the currently known lithium-ion batteries. However, to ensure a highly ordered structure and respectively good capacity and cycle life, an excess of lithium compounds than the stoichiometric amount is used during the synthesis of the positive electrode material. Typically, an excess of lithium is between 5-10 mole %, but it can also vary from 0.1-30 mole % based on the total moles of transition metals. These excess lithium compounds may contain a significant amount of chemically bound water that can be released during the cell life. It is believed that the excess lithium forms a composite of LiOH (lithium hydroxide), Li₂CO₃ (lithium carbonate) and LiHCO₃ (lithium bicarbonate) in the final product with a varying range of ratios, depending on the synthesis and the storage conditions. For example, LiOH may be the main component of the lithium excess for a freshly synthesized material, while LiHCO₃ may be the main component of the lithium excess after being stored at ambient atmosphere. It is thus believed that the nickel-cobalt-based positive electrode material for a lithium-ion battery is more precisely expressed with the formula:
LiNi_{X}CO_{Y}M_{Z}O₂.(LiOH)ₖ(Li₂CO₃)ₘ(LiHCO₃)ₙ
where M represents a transition metal or a sum of transition metals different from Ni and Co and where X+Y+Z≈1, X>Y, Z<0.5 and 0.001<k+m+n<0.3.

The presence of LiOH and LiHCO₃ compounds in the lithium excess composite is believed to significantly increase the moisture in the cell. For example, the presence of LiHCO₃ may generate moisture in the cell during the cell's life according to the equilibrium:
2LiHCO₃→Li₂CO₃+CO₂+H₂O
while the LiOH may react with the existing CO₂ in the cell to generate moisture according to the reaction:
2LiOH+CO₂→Li₂CO₃+H₂O
CO₂ is a main product of the self-discharge of both positive and negative electrodes in lithium and lithium-ion batteries, such that moisture generation is highly likely in the presence of any LiOH. The negative effects of moisture in lithium and lithium-ion batteries are well established. It has been shown that the moisture increases the self-discharge of both positive and negative electrodes and strongly reduces the cycle and calendar life of the cell. Additionally, because part of the shelf discharge products are gasses, an increase in the moisture content significantly increases the cell gassing, which may cause fast cell deterioration, particularly for soft pack cells.

There is thus a need for a lithiated nickel-based positive electrode material having reduced moisture-containing compounds, particularly those that are strongly bound to the positive electrode active material, to reduce cell moisture generation and gassing during battery operation.

### SUMMARY OF THE INVENTION

The present invention provides a composite positive electrode material of the formula:
LiNi_{X}Co_{Y}M_{Z}O₂.(LiOH)ₖ(Li₂CO₃)ₘ(LiHCO₃)ₙ
wherein M is one or more transition metals different than nickel and cobalt, X+Y+Z=1, X>Y and Z<0.5. In this composite, the water-containing compounds LiOH and LiHCO₃ are held to a combined content of at least 10 times lower than the content of the water-free compound Li₂CO₃. Advantageously, the sum of the amounts of LiOH and LiHCO₃ is more than 100 times lower than the amount of Li₂CO₃, and more advantageously, more than 1,000 times lower than the amount of Li₂CO₃. The present invention further provides a lithium-ion battery comprising the positive electrode material with the significantly reduced amount of LiOH and LiHCO₃.

### DETAILED DESCRIPTION

To address the negative effects of moisture in lithium-ion batteries, the present invention provides a positive electrode material having low amounts of LiOH and LiHCO₃ compounds. A lithiated nickel-based positive electrode material is used for the positive electrode material due to its high specific energy. The main component of the positive electrode material may have the general formula LiNi_{X}Co_{Y}M_{Z}O₂, where M is a transition metal or the sum of transition metals different than Ni and Co. Advantageously, the nickel fraction is greater than the cobalt fraction, and the cobalt fraction may be 0. The transition metals other than Ni and Co are advantageously no greater than a ½ fraction. In other words, X≧Y, Z<0.5 and X+Y+Z=1. Because the positive electrode material is generally prepared using an excess of lithium compounds than the stoichiometric amount to provide a highly ordered structure, the excess of lithium may vary from 0.1-30 mole % and typically is from 1-10 mole % based on the total moles of transition metals. The excess lithium forms a composite of LiOH, Li₂CO₃ and LiHCO₃, with the ratios of these components varying depending on the synthesis and storage conditions. The LiOH and LiHCO₃ compounds contain a significant amount of chemically bound water, which can be released during the cell life, whereas Li₂CO₃ is a water-free compound. Thus, in accordance with the present invention, the positive electrode material is prepared and/or treated so as to result in the excess lithium being formed predominantly as Li₂CO₃, while limiting or eliminating the content of LiOH and LiHCO₃ compounds in the composite. To prevent moisture generation and gassing in the cell during the cell's life, the sum of LiOH and LiHCO₃ is controlled to a value less than 1/10 the amount of Li₂CO₃. Thus, where the excess lithium forms the composite (LiOH)ₖ(Li₂CO₃)ₘ(LiHCO₃)ₙ, the sum of k+m+n=0.01-0.3 and k+n<0.1m. To further reduce moisture generation and gassing, the LiOH and LiHCO₃ content (i.e., k+n) is maintained at a level more than 100 times below the amount of Li₂CO₃ (i.e., 0.01m). To even further reduce moisture generation and gassing in the cell, the LiOH and LiHCO₃ content (i.e., k+n) is maintained at a level more than 1,000 times below the amount of Li₂CO₃ (i.e., 0.001m).

To achieve the positive electrode material of the present invention, the positive electrode material may be treated in accordance with the method set forth in commonly owned, copending application Ser. No. ______ DP-309341, filed on even date and entitled METHOD OF PREPARATION OF POSITIVE ELECTRODE MATERIAL, the disclosure of which is incorporated by reference herein in its entirety. The method disclosed therein includes one treatment in which the positive electrode material is exposed at a temperature of 0-650° C. to a CO₂-containing gas having a partial pressure of CO₂ in the range of 0.0001-100 atm to convert LiOH to Li₂CO₃. The method disclosed therein also includes a treatment in which the positive electrode material is heated to a temperature of at least 250° C. in the presence of an oxygen-containing gas having a partial pressure of O₂ in the range of 0.01-99 atm to convert LiHCO₃ to Li₂CO₃. In accordance with the present invention, the positive electrode material may be treated by either of those treatment methods, as dictated by the relative component amounts resulting after synthesis or after synthesis and storage, or may be subjected to both treatments, either sequentially or concurrently. For concurrent treatment, the positive electrode material may be heated to a temperature of 250-650° C. in the presence of an oxygen-containing gas having a partial pressure of O₂ in the range of 0.01-99 atm to convert the LiHCO₃ to Li₂CO₃ and in the presence of a CO₂-containing gas having a partial pressure of CO₂ in the range of 0.0001-100 atm to convert LiOH to Li₂CO₃.

In addition to the post-synthesis treatment method described above, other methods for controlling the relative contents of LiOH, LiHCO₃ and Li₂CO₃ may be employed, including process controls or treatments carried out during synthesis of the positive electrode material, after synthesis but before storage, or after storage of the positive electrode material.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

1. A positive electrode material for a lithium-ion or lithium-ion polymer battery, having the formula
LiNi_{X}Co_{Y}M_{Z}O₂.(LiOH)ₖ(Li₂CO₃)ₘ(LiHCO₃)ₙ
wherein M is one or more transition metals different than Ni and Co, X+Y+Z=1, X≧Y, Z<0.5, 0.001<k+m+n<0.3, and k+n<0.1m.

2. The positive electrode material of claim 1 wherein k+n<0.01m.

3. The positive electrode material of claim 1 wherein k+n<0.001m.

4. The positive electrode material of claim 1 wherein Y−0.

5. The positive electrode material of claim 4 wherein k+n<0.01m.

6. The positive electrode material of claim 4 wherein k+n<0.001m.

7. The positive electrode material of claim 1 prepared by exposing the positive electrode material at a temperature of 0-650° C. to a CO₂-containing gas having a partial pressure of CO₂ in the range of 0.0001-100 atm to convert LiOH to Li₂CO₃.

8. The positive electrode material of claim 7 further prepared by heating the positive electrode material to a temperature of at least 250° C. in the presence of an oxygen-containing gas having a partial pressure of O₂ in the range of 0.01-99 atm to convert LiHCO₃ to Li₂CO₃.

9. The positive electrode material of claim 1 prepared by heating the positive electrode material to a temperature of at least 250° C. in the presence of an oxygen-containing gas having a partial pressure of O₂ in the range of 0.01-99 atm to convert LiHCO₃ to Li₂CO₃.

10. The positive electrode material of claim 1 prepared by heating the positive electrode material to a temperature of 250-500° C. in the presence of an oxygen-containing gas having a partial pressure of O₂ in the range of 0.01-99 atm to convert LiHCO₃ to Li₂CO₃ and in the presence of a CO₂-containing gas having a partial pressure of CO₂ in the range of 0.0001-100 atm to convert LiOH to Li₂CO₃.

11. A lithium ion battery comprising a positive electrode material of the formula
LiNi_{X}Co_{Y}M_{Z}O₂.(LiOH)ₖ(Li₂CO₃)ₘ(LiHCO₃)ₙ
wherein M is one or more transition metals different than Ni and Co, X+Y+Z=1, X≧Y, Z<0.5, 0.001<k+m+n<0.3, and k+n<0.1m.

12. The lithium ion battery of claim 11 wherein k+n<0.01m.

13. The lithium ion battery of claim 11 wherein k+n<0.001m.

14. The lithium ion battery of claim 11 wherein Y=0.

15. The lithium ion battery of claim 14 wherein k+n<0.01m.

16. The lithium ion battery of claim 14 wherein k+n<0.001m.

17. The lithium ion battery of claim 11 wherein the positive electrode material is prepared by exposing the positive electrode material at a temperature of 0-650° C. to a CO₂-containing gas having a partial pressure of CO₂ in the range of 0.0001-100 atm to convert LiOH to Li₂CO₃.

18. The lithium ion battery of claim 17 wherein the positive electrode material is further prepared by heating the positive electrode material to a temperature of at least 250° C. in the presence of an oxygen-containing gas having a partial pressure of O₂ in the range of 0.01-99 atm to convert LiHCO₃ to Li₂CO₃.

19. The lithium ion battery of claim 11 wherein the positive electrode material is prepared by heating the positive electrode material to a temperature of at least 250° C. in the presence of an oxygen-containing gas having a partial pressure of O₂ in the range of 0.01-99 atm to convert LiHCO₃ to Li₂CO₃.

20. The lithium ion battery of claim 11 wherein the positive electrode material is prepared by heating the positive electrode material to a temperature of 250-500° C. in the presence of an oxygen-containing gas having a partial pressure of O₂ in the range of 0.01-99 atm to convert LiHCO₃ to Li₂CO₃ and in the presence of a CO₂-containing gas having a partial pressure of CO₂ in the range of 0.0001-100 atm to convert LiOH to Li₂CO₃.
